(19) United States
(12) Patent Application Publication
(10) Pub. No.: US 2006/0199753 A1
(43) Pub. Date: Sep. 7, 2006

(54) Detergent compositions

(75) Inventors: Anju Deepali Massey Brooker, Newcastle/Tyne (GB); Alan Thomas Brooker, Newcastel/Tyne (GB); Julie Ellis, Newcastle/Tyne (GB); Nathalie Sophie Letzelter, Newcastle/Tyne (GB); Andrew Paul Nelson, Newcastle/Tyne (GB); Eric San Jose Robles, Newcastle/Tyne (GB); Nigel Patrick Somerville Roberts, Newcastle/Tyne (GB)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/369,359

(22) Filed: Mar. 7, 2006

(30) Foreign Application Priority Data
Mar. 7, 2005 (EP) 05004970.9

(51) Int. Cl. C11D 3/00

(52) U.S. Cl. 510/375

(57) ABSTRACT

Detergent or bleach composition for use in automatic dishwashing comprising a colour stain cleaning system comprising diacyl and/or tetraacyl peroxide bleaching species and a co-bleaching surfactant wherein the diacyl peroxide bleaching species is selected from diacyl peroxides of the general formula:
R¹—C(O)—OO—(O)C—R²
in which R¹ represents a C₆-C₁₈ alkyl group and R² represents an aliphatic group compatible with a peroxide moiety, such that R¹ and R² together contain a total of 8 to 30 carbon atoms; the tetraacyl peroxide bleaching species is selected from tetraacyl peroxides of the general formula:
R³—C(O)—OO—C(O)—(CH₂)ₙ—C(O)—OO—C(O)—R³
in which R³ represents a C₁-C₉ alkyl group and n represents an integer from 2 to 12; and wherein the co-bleaching surfactant comprises a cleaning surfactant selected from ethoxylated alcohols, amine oxide surfactants and mixtures thereof.

### TECHNICAL FIELD

The present invention relates to detergent and bleach compositions comprising a diacyl and/or tetraacyl peroxide bleaching species and having improved bleaching performance.

### BACKGROUND OF THE INVENTION

A well recognized problem arising during automatic dishwashing is the removal of colour stains from plastic and other hydrophobic substrates. WO 95/19132 suggests the use of diacyl and/or tetraacyl peroxide bleaching species to enhance the removal of bleachable soils from a plastic substrate.

It has been found that as the dishwashing conditions become more stressed ie, dishwashing loads have higher levels of soil, the solution proposed by '132 produces increasingly unsatisfactory results.

### SUMMARY OF THE INVENTION

According to the first aspect of the invention there is provided a detergent or bleach composition for use in automatic dishwashing comprising a colour stain cleaning system comprising diacyl and/or tetraacyl peroxide bleaching species and a co-bleaching surfactant wherein the diacyl peroxide bleaching species is selected from diacyl peroxides of the general formula:
R¹—C(O)—OO—(O)C—R²
in which R¹ represents a C₆-C₁₈ alkyl group and R² represents an aliphatic group compatible with a peroxide moiety, such that R¹ and R² together contain a total of 8 to 30 carbon atoms; the tetraacyl peroxide bleaching species is selected from tetraacyl peroxides of the general formula:
R³—C(O)—OO—C(O)—(CH₂)ₙ—C(O)—OO—C(O)—R³
in which R³ represents a C₁-C₉ alkyl group and n represents an integer from 2 to 12; and wherein the co-bleaching surfactant preferably comprises a cleaning surfactant selected from ethoxylated alcohols, amine oxide surfactants and mixtures thereof.

Colour stains are mainly caused by soils which contain tomato soils, such as lasagne, carotene soils, such as cooked carrots (also known as lycopene soils), curry sauce and mixtures thereof. These stains are particularly difficult to remove from hydrophobic surfaces, such as plastic. The cleaning is more difficult in the presence of soil in the dishwasher. Compositions capable of removing colour stains in the absence of other soils do not seem to be capable of achieving similar degree of removal in the presence of soils (as is the case in a normal dishwashing load), this effect is more acute in the case of dishwashing loads containing a high level of greasy/oily soils. Satisfactory stain removal may not be achieved even with relatively high levels of the bleaching species. Improved coloured stain removal is achieved with the compositions of the invention.

By “co-bleaching surfactant” is meant a surfactant which helps the diacyl and/or tetraacyl bleaching species to perform its bleaching function. The co-bleaching surfactant can be a single surfactant but preferably is a mixture thereof. The ethoxylated alcohols surfactants for use herein are essentially free of alkoxy groups other than ethoxy groups.

In a preferred embodiment the co-bleaching surfactant, preferably in the case in which the co-bleaching surfactant comprises an ethoxylated alcohol, has a cloud point above wash temperature, ie, above about 50° C., more preferably above about 60° C.

Without wishing to be bound by theory is believed that the bleaching species has a low solubility in water, which seems to be improved by the co-bleaching surfactant. Moreover, the co-bleaching surfactant seems to preclude the re-aggregation of bleaching species, further contributing to their solubilization. It is also believed that the co-bleaching surfactant helps to drive the bleaching species to the soiled substrates. Furthermore, the surfactant seems to emulsify greasy soils preventing re-deposition on the substrates. The bleaching species cannot only act on the soils attached to the substrates but also on the emulsified soils. The combination of all these factors gives rise to compositions with improved colour stain removal capacity.

Preferably, the composition comprises a mixture of a co-bleaching surfactant (ethoxylated alcohols, amine oxide surfactants and mixtures thereof) and a low foaming non-ionic surfactant acting as a suds suppressor. In the case in which the co-bleaching surfactant comprises an ethoxylated alcohol, preferably the ethoxylated alcohol and the suds suppressor are in a weight ratio of at least about 1:1, more preferably about 1.5:1 and even more preferably about 1.8:1. This is preferred from a performance point of view.

It has been found that a relatively high level of total surfactant is preferred in order to achieve optimum performance. Thus, in a preferred embodiment, the total surfactant is present in an amount sufficient to provide at least about 50 ppm, more preferably at least about 100 ppm and even more preferably at least about 400 ppm by weight of the wash liquor.

In preferred embodiments the co-bleaching surfactant is an ethoxylated alcohol and the composition further comprises an enzyme. These compositions allow optimum colour stain removal and at the same time optimum enzymatic soil removal. Some cleaning surfactants present a tendency to interact with enzymes, reducing their performance, however, this interaction does not seem to exist in the case of ethoxylated alcohol surfactants.

Preferably, the diacyl and/or tetraacyl peroxide bleaching species is present in an amount sufficient to provide at least 0.5 ppm, more preferably at least 10 ppm, and even more preferably at least 50 ppm by weight of the wash liquor. In a preferred embodiment, the bleaching species is present in an amount sufficient to provide from about 0.5 to about 60 ppm, more preferably from about 5 to about 30 ppm by weight of the wash liquor.

In another preferred embodiment, the total surfactant and the bleaching species are in a weight ratio of at least about 3:1, more preferably at least about 5:1 and even more preferably in a weight ratio of at least about 8:1, these ratios guarantee an optimum performance of the bleaching species.

In another aspect of the invention, there is provided a detergent or bleach composition for use in automatic dishwashing comprising a colour stain cleaning system comprising diacyl and/or tetraacyl peroxide bleaching species and a co-bleaching surfactant wherein the diacyl peroxide bleaching species is selected from diacyl peroxides of the general formula:
R¹—C(O)—OO—(O)C—R²
in which R¹ represents a C₆-C₁₈ alkyl group and R² represents an aliphatic group compatible with a peroxide moiety, such that R¹ and R² together contain a total of 8 to 30 carbon atoms; the tetraacyl peroxide bleaching species is selected from tetraacyl peroxides of the general formula:
R³—C(O)—OO—C(O)—(CH₂)ₙ—C(O)—OO—C(O)—R³
in which R³ represents a C₁-C₉ alkyl group and n represents an integer from 2 to 12; and wherein the co-bleaching surfactant has a cloud point above wash temperature, i.e, above about 50° C., more preferably above about 60° C.

In still another aspect of the invention, there is provided a detergent or bleach composition for use in automatic dishwashing comprising a colour stain cleaning system comprising diacyl and/or tetraacyl peroxide bleaching species and a co-bleaching surfactant wherein the diacyl peroxide bleaching species is selected from diacyl peroxides of the general formula:
R¹—C(O)—OO—(O)C—R²
in which R¹ represents a C₆-C₁₈ alkyl group and R² represents an aliphatic group compatible with a peroxide moiety, such that R¹ and R² together contain a total of 8 to 30 carbon atoms; the tetraacyl peroxide bleaching species is selected from tetraacyl peroxides of the general formula:
R³—C(O)—OO—C(O)—(CH₂)ₙ—C(O)—OO—C(O)—R³
in which R³ represents a C₁-C₉ alkyl group and n represents an integer from 2 to 12; and wherein the co-bleaching surfactant and the bleaching species are in a weight ratio of at least about 5:1, preferably at least about 8:1 and more preferably at least about 10:1.

The compositions of the invention are preferably in powder or any other solid form. Usually the surfactant is in liquid or paste form and the level of surfactant is high, this may negatively affect the stability of the bleaching species. This problem can be overcome or minimized by the use of a multi-compartment unit dose product such as a pouch, in which part or all of the surfactant can be placed in a different compartment to that in which the bleaching species is located, reducing the host-guest complex/surfactant interaction, thereby improving the stability of the composition.

According to another aspect of the invention, there is provided a method of cleaning colour stained hydrophobic substrates in the presence of soil using the compositions of the invention, in a preferred embodiment the cleaning takes place at a temperature below the cloud point of the co-bleaching surfactant. It is also preferred that the wash liquor comprises from about 500 to about 400 ppm, more preferably from about 100 to about 300 ppm of co-bleaching surfactant and from about 0.5 to about 60 ppm, more preferably from about 5 to about 40 ppm of bleaching species by weight of the wash liquor. The method provides single and multi-cycles benefits, as well as prevention of re-deposition of colour stains on the washed substrates.

### DETAILED DESCRIPTION OF THE INVENTION

The present invention relates to detergent and bleaching compositions comprising a diacyl and/or tetraacyl peroxide species of certain formula. The compositions are preferably in solid or unit dose form, eg in powder, tablet or pouch form but can also be in liquid form. Liquid type compositions include formulations in which the liquid does not react with the bleaching species, such as anhydrous formulations. The detergent compositions are particularly useful for the removal of colour stains from hydrophobic substrates in an automatic dishwashing process in the presence of high soils. The bleaching composition can be used as additives, in combination with other detergent compositions or by themselves.

The detergent and bleaching compositions herein comprise traditional detergency components. The compositions, especially the detergent compositions, will generally be built and comprise one or more detergent active components which may be selected from colorants, additional bleaching agents, surfactants, alkalinity sources, enzymes, anti-corrosion agents (e.g. sodium silicate) and disrupting agents (in the case of powder, granules or tablets). Highly preferred detergent components include a builder compound, an alkalinity source, a surfactant, an enzyme and an additional bleaching agent. Preferably, the compositions of the invention comprise an additional bleaching agent in addition to the diacyl and/or tetraacyl peroxide. Preferably the additional bleaching agent is a percarbonate, in a level of from about 1% to about 80% by weight of the composition, in the case of a detergent composition the level is from about 2% to about 40%, more preferably from about 3% to about 30% by weight of the composition.

Diacyl and Tetraacyl Peroxide Bleaching Species

The diacyl peroxide bleaching species is selected from diacyl peroxides of the general formula:
R¹—C(O)—OO—(O)C—R²
in which R¹ represents a C₆-C₁₈ alkyl, preferably C₆-C₁₂ alkyl group containing a linear chain of at least 5 carbon atoms and optionally containing one or more substituents (e.g. —N⁺(CH₃)₃, —COOH or —CN) and/or one or more interrupting moieties (e.g. —CONH— or —CH═CH—) interpolated between adjacent carbon atoms of the alkyl radical, and R² represents an aliphatic group compatible with a peroxide moiety, such that R¹ and R² together contain a total of 8 to 30 carbon atoms. In one preferred aspect R¹ and R² are linear unsubstituted C₆-C₁₂ alkyl chains. Most preferably R¹ and R² are identical. Diacyl peroxides, in which both R¹ and R² are C₆-C₁₂ alkyl groups, are particularly preferred.

The tetraacyl peroxide bleaching species is selected from tetraacyl peroxides of the general formula:
R³—C(O)—OO—C(O)—(CH₂)ₙ—C(O)—OO—C(O)—R³
in which R³ represents a C₁-C₉ alkyl, preferably C₃-C₇, group and n represents an integer from 2 to 12, preferably 4 to 10 inclusive.

The diacyl and tetraacyl bleaching species are preferably incorporated into the compositions of the invention as “guest” molecules in “host-guest complexes” in which the molecules of the bleaching species are individually separated from each other by their inclusion in the host receptor sites. This improves storage stability. The hosts may for example be inorganic or organic crystals having relatively open structures which provide sites that may be occupied by guest molecules, thus forming the host-guest complexes. Examples of suitable hosts include certain clathrates or inclusion compounds, including the urea clathrates and the cyclodextrins, particularly the beta-cyclodextrins. The hosts are most preferably water soluble, to enable effective release and dispersion of the bleaching species on introduction of the host-bleaching species complexes into an aqueous media, such as a wash solution. Urea clathrates of diacyl and tetraacyl bleaching species have been disclosed in both WO 93/07086 and WO 95/19132.

Preferably the bleaching species is a diacyl peroxide wherein R¹ and R² are both C₆-C₁₂ unsubstituted alkyl group, more preferred for use herein are diacyl peroxide wherein both is R¹ and R² are C8, C9, C10 or C11. Preferably, the host-guest complex is a urea clathrate. Apparently, the urea form a three-dimensional network of cavities in which the peroxide molecules are hosted, precluding the interaction between peroxide molecules and thereby reducing the instability of the peroxide. The urea is highly water soluble readily releasing the bleaching species into the cleaning liquor.

Preferably the host-guest complex is in the form of an aggregate. The term “aggregate” refers broadly to the secondary particles formed by aggregation of primary host-guest complex particles according to any of the well known powder-processing technique including granulation, agglomeration, extrusion, compaction, encapsulation, etc.

Preferably, the host-guest complex has an aggregate particle size of at least about 106 μm (more than about 50% by weight of the aggregate particles are retained on a sieve having a mesh of 106 μm aperture (Sieve size No. 140, US mesh 105)) and a density of at least about 500 g/l more preferably the aggregate has a density of at least about 600 g/l and even more preferably of at least about 700 g/l.

Co-Bleaching Surfactant

The co-bleaching surfactant can be a single surfactant or a mixture thereof, preferably including one or more co-bleaching surfactants having a cloud point above wash temperature ie, preferably above about 40° C., more preferably above about 50° C. and even more preferably above about 60° C. “Cloud point”, as used herein, is a well known property of surfactants and mixtures thereof which is the result of the surfactant becoming less soluble with increasing temperature, the temperature at which the appearance of a second phase is observable is referred to as the “cloud point” (See KirkOthmer's Encyclopedia of Chemical Technology, 3rd Ed., Vol. 22, pp. 360-362).

Preferred co-bleaching surfactants for use herein include both liner and branched alkyl ethoxylated condensation products of aliphatic alcohols with an average of from about 4 to about 10, preferably form about 5 to about 8 moles of ethylene oxide per mol of alcohol are suitable for use herein. The alkyl chain of the aliphatic alcohol generally contains from about 6 to about 15, preferably from about 8 to about 14 carbon atoms. Particularly preferred are the condensation products of alcohols having an alkyl group containing from about 8 to about 13 carbon atoms with an average of from about 6 to about 8 moles of ethylene oxide per mole of alcohol. Preferably at least 25%, more preferably at least 75% of the surfactant is a straight-chain ethoxylated primary alcohol. It is also preferred that the HLB (hydrophilic-lipophilic balance) of the surfactant be less than about 18, preferably less than about 15 and even more less than 14. Preferably, the surfactant is substantially free of propoxy groups. Commercially available products for use herein include Lutensol®TO series, C13 oxo alcohol ethoxylated, supplied by BASF, especially suitable for use herein being Lutensol®TO7.

Amine oxides surfactants are also useful in the present invention and include linear and branched compounds having the formula: 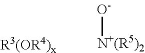
wherein R³ is selected from an alkyl, hydroxyalkyl, acylamidopropoyl and alkyl phenyl group, or mixtures thereof, containing from 8 to 26 carbon atoms, preferably 8 to 18 carbon atoms; R⁴ is an alkylene or hydroxyalkylene group containing from 2 to 3 carbon atoms, preferably 2 carbon atoms, or mixtures thereof; x is from 0 to 5, preferably from 0 to 3; and each R⁵ is an alkyl or hydroxyalkyl group containing from 1 to 3, preferably from 1 to 2 carbon atoms, or a polyethylene oxide group containing from 1 to 3, preferable 1, ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₈ alkoxy ethyl dihydroxyethyl amine oxides. Examples of such materials include dimethyloctylamine oxide, diethyldecylamine oxide, bis-(2-hydroxyethyl)dodecylamine oxide, dimethyldodecylamine oxide, dipropyltetradecylamine oxide, methylethylhexadecylamine oxide, dodecylamidopropyl dimethylamine oxide, cetyl dimethylamine oxide, stearyl dimethylamine oxide, tallow dimethylamine oxide and dimethyl-2-hydroxyoctadecylamine oxide. Preferred are C10-C₁₈ alkyl dimethylamine oxide, and C₁₀₋₁₈ acylamido alkyl dimethylamine oxide.

Suds Suppresser

The surfactants for use as suds suppressers are preferably non-ionic surfactants having a low cloud point. As used herein, a “low cloud point” non-ionic surfactant is defined as a non-ionic surfactant system ingredient having a cloud point of less than 30° C., preferably less than about 20° C., and even more preferably less than about 10° C., and most preferably less than about 7.5° C. Typical low cloud point non-ionic surfactants include non-ionic alkoxylated surfactants, especially ethoxylates derived from primary alcohol, and polyoxypropylene/polyoxyethylene/polyoxypropylene (PO/EO/PO) reverse block polymers. Also, such low cloud point non-ionic surfactants include, for example, ethoxylated-propoxylated alcohol (e.g., Olin Corporation's Poly-Tergent® SLF18) and epoxy-capped poly(oxyalkylated) alcohols (e.g., Olin Corporation's Poly-Tergent® SLF18B series of non-ionics, as described, for example, in U.S. Pat. No. 5,576,281).

Other suitable low cloud point surfactants are the ether-capped poly(oxyalkylated) suds suppresser having the formula: 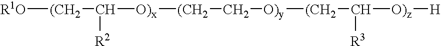
wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point non-ionic surfactants are the ether-capped poly(oxyalkylated) having the formula:
R_{I}O(R_{II}O)ₙCH(CH₃)OR_{III}
wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:
(i) a 4 to 8 membered substituted, or unsubstituted heterocyclic ring containing from 1 to 3 hetero atoms; and
(ii) linear or branched, saturated or unsaturated, substituted or unsubstituted, cyclic or acyclic, aliphatic or aromatic hydrocarbon radicals having from about 1 to about 30 carbon atoms;
(b) provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

If non-ionic suds suppressers are used they are preferably used in a level of from about 5% to about 40%, preferably from about 8% to about 35% and more preferably form about 10% to about 25% by weight of the composition.

The co-bleaching surfactant is preferably used in the compositions of the invention at a level of from about 2% to about 30%, more preferably from about 4% to about 25% and even more preferably form about 3% to about 20% by weight of the composition. It is also preferred that the ethoxylated alcohols, the amine oxide surfactants and the mixtures thereof are in a level of at least about 2%, more preferably about 3% by weight of the composition. In preferred embodiments the ethoxylated alcohols are in a level above about 3%, more preferably above about 4% by weight of the composition.

### EXAMPLES

Abbreviations Used in Examples

In the examples, the abbreviated component identifications have the following meanings:
Carbonate: Anhydrous sodium carbonate
STPP: Sodium tripolyphosphate
Silicate: Amorphous Sodium Silicate (SiO₂:Na₂O=from 2:1 to 4:1)
Percarbonate: Sodium percarbonate of the nominal formula 2Na₂CO₃.3H₂O₂
Amylase: α-amylase available from Novo Nordisk A/S
Protease: protease available from Genencor
Lutensol TiO7: C13 oxo alcohol ethoxylated, available from BASF
Amine Oxide; tetradecyl dimethyl amine oxide
SLF18: Poly-Tergent® available from BASF
LF224: Fatty alcohol alkoxylated non-ionic surfactant available from BASF
Alcosperse 240: sulfonated polymer available from Alco Chemical
DPG: dipropylene glycol

In the following examples all levels are quoted as percent (%) by weight.

Compositions A to C are introduced into dual superposed compartment PVA rectangular base pouches. The dual compartment pouches are made from a Monosol M8630 film, supplied by Chris-Craft Industrial Products. 18 g of the solid composition and 2 g of the liquid composition are placed in the two different compartments of the pouches. The pouches are manufactured by making open pockets with PVA film, filling them with the solid composition, placing a PVA film over the open pockets and sealing the two films to create new open pockets, the new pockets are filled with the liquid composition, a piece of PVA is placed over them and the new pockets are sealed giving rise to a dual compartment pouch.

| | A | B | C |
|---|---|---|---|
| Particulate composition | | | |
| Anhydrous STPP | 33 | 37 | 35 |
| Sodium Silicate | 4 | 4 | 4 |
| Sodium Carbonate | 23 | 27 | 25 |
| Amylase | 1 | 1.5 | 1 |
| Protease | 2 | 1.5 | 2 |
| Percarbonate | 20 | 20 | 20 |
| DAP | 0.8 | 0.8 | 0.6 |
| Lutensol TO7 | | | 1.5 |
| Amine Oxide | | 0.5 | |
| LF224 | | 3.2 | |
| SLF18 | | | 0.75 |
| Perfume | 0.2 | 0.2 | 0.2 |
| Alcosperse 240 | 3 | 3 | 3 |
| Mis/moisture to balance | | | |
| Liquid composition | | | |
| DPG | 29.2 | 45 | 30 |
| Glycerine | 3 | 5 | 3 |
| Lutensol TO7 | 50 | | 40 |
| Amine Oxide | | 5 | |
| LF224 | 25 | 32 | |
| SLF18 | | | 20 |
| Dye | 0.8 | 0.8 | 0.8 |
| Water to balance | | | |

The efficacy of the compositions of the invention is tested by washing 2 rubber-maid spatulas stained with Ragu original sauce in a Bosch 6032 dishwasher. The spatulas are pre-stained by placing them into the dishwasher on the 65E cycle with 100 g of Ragu original sauce added into the main-wash.

The two pre-stained spatulas are placed in the cutlery basket of a Bosch 6032. A pouch of composition A is placed into the dispenser of the dishwasher. The 65E cycle is run. 40 g or Ragu original sauce is added at the start of the main wash. Excellent cleaning performance is achieved.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A detergent or bleach composition for use in automatic dishwashing comprising a colour stain cleaning system comprising diacyl and/or tetraacyl peroxide bleaching species and a co-bleaching surfactant wherein the diacyl peroxide bleaching species is selected from diacyl peroxides of the general formula:
R¹—C(O)—OO—(O)C—R²
in which R¹ represents a C₆-C₁₈ alkyl group and R² represents an aliphatic group compatible with a peroxide moiety, such that R¹ and R² together contain a total of 8 to 30 carbon atoms; the tetraacyl peroxide bleaching species is selected from tetraacyl peroxides of the general formula:
R³—C(O)—OO—C(O)—(CH₂)ₙ—C(O)—OO—C(O)—R³
in which R³ represents a C₁-C₉ alkyl group and n represents an integer from 2 to 12; and wherein the co-bleaching surfactant is selected from the group comprising ethoxylated alcohols, amine oxide surfactants and mixtures thereof.

2. A composition according to claim 1 wherein the composition comprises a low foaming non-ionic surfactant acting as a suds suppressor.

3. A composition according to claim 1 wherein the co-bleaching surfactant has a cloud point above washing temperature and wherein the total surfactant is present in an amount sufficient to provide at least about 50 ppm by weight of the wash liquor.

4. A composition according to claim 1 wherein the co-bleaching surfactant is an ethoxylated alcohol and the composition further comprises an enzyme.

5. A composition according to claim 1 wherein the bleaching species is present in an amount sufficient to provide from about 0.5 to about 60 ppm by weight of the wash liquor.

6. A composition according to claim 1 wherein the total co-bleaching surfactant and the bleaching species are in a weight ratio of at least about 3:1.

7. A composition according to claim 1 in the form of a multi-compartment pouch wherein one of the compartments contains a powder comprising the bleaching species and another compartment contains a liquid comprising co-bleaching surfactant.

8. A method of cleaning colour stained hydrophobic substrates in the presence of soil comprising the steps of:
a) introducing a soiled load including colour stained hydrophobic substrates into a dishwasher;
b) treating the soiled load with a wash liquor comprising diacyl and/or tetraacyl peroxide bleaching species and a co-bleaching surfactant wherein the diacyl peroxide bleaching species is selected from diacyl peroxides of the general formula:
R¹—C(O)—OO—(O)C—R²
in which R¹ represents a C₆-C₁₈ alkyl group and R² represents an aliphatic group compatible with a peroxide moiety, such that R¹ and R² together contain a total of 8 to 30 carbon atoms; the tetraacyl peroxide bleaching species is selected from tetraacyl peroxides of the general formula:
R³—C(O)—OO—C(O)—(CH₂)ₙ—C(O)—OO—C(O)—R³
in which R³ represents a C₁-C₉ alkyl group and n represents an integer from 2 to 12; and
wherein the co-bleaching surfactant is selected from the group comprising ethoxylated alcohol, amine oxide surfactant and mixtures thereof.

9. A method according to claim 8 wherein the washing temperature is below the cloud point of the co-bleaching surfactant and wherein the wash liquor comprises from about 50 to about 400 of co-bleaching surfactant and from about 0.5 to about 60 ppm of bleaching species by weight of the wash liquor.
